(19) United States
(12) Patent Application Publication
(10) Pub. No.: US 2013/0151323 A1
(43) Pub. Date: Jun. 13, 2013

(54) SYSTEMS AND METHODS FOR FACILITATING ISSUANCE AND REDEMPTION OF A REWARD

(71) Applicant: Visa International Service Association, San Francisco, CA (US)

(72) Inventors: David Shepard, Novato, CA (US); Karteek Patel, Napa, CA (US); Leigh Amaro, Redwood City, CA (US); Vicki Kincaid, Mountain View, CA (US)

(73) Assignee: Visa International Service Association, San Francisco, CA (US)

(21) Appl. No.: 13/707,280

(22) Filed: Dec. 6, 2012

Related U.S. Application Data
(60) Provisional application No. 61/568,122, filed on Dec. 7, 2011.

(51) Int. Cl. G06Q 30/02

(52) U.S. Cl. CPC G06Q 30/0222
USPC 705/14.23

(57) ABSTRACT

A computing apparatus is configured to receive, from a transaction handler of a payment network, an authorization request for a payment transaction. The authorization request identifies a full transaction amount, as well as information identifying the merchant and the cardholder involved in the transaction. The computing apparatus is configured to determine the cardholder's eligibility to receive a reward based on information provided in the authorization request, as well as offer information stored in association with the account information of the cardholder. When the cardholder is eligible for a reward, the computing apparatus deducts a reward amount from the transaction amount to authorize a partial amount for the transaction and provides a partial authorization response for the payment transaction. The partial authorization response may optionally include a description of the offer, the reward and/or an identifier of the offer.

### CROSS REFERENCE TO RELATED APPLICATIONS

The present application claims priority to Prov. U.S. Pat. App. Ser. No. 61/568,122, filed Dec. 7, 2011 and entitled “Systems and Methods for Facilitating Issuance and Acceptance of a Reward”, the entire disclosure of which application is hereby incorporated herein by reference.

### FIELD OF THE TECHNOLOGY

At least some embodiments of the present disclosure relate to programming operations to be performed by computing apparatuses in general, and more particularly, but not limited to, programming operations, such as information delivery and processing, based on the processing of data for determining reward eligibility and a reward amount based on a financial transaction and facilitating reward redemption at the time of the financial transaction.

### BACKGROUND

Credit card reward programs typically provide credit card customers (i.e., cardholders) with rewards such as points, miles, or statement credit that are generally based on the dollar amounts of goods or services purchased using the credit card. These rewards are typically reflected in the cardholder's monthly statement or may be tracked by a third-party reward company, which may communicate the reward totals to the cardholder in quarterly, monthly, or online statements.

Upon becoming eligible and having a sufficient quantity of accumulated rewards, the cardholder may choose to apply a balance of the accumulated rewards toward a purchase. Depending on the reward type, the rewards may be redeemed to obtain or offset the cost of airfare, offset the cost of a purchase, or obtain a free gift, for example.

While reward programs have been implemented across many industries and have taken many forms, the underlying principles of how they operate have remained fairly constant. The manners by which reward programs are managed and the rules governing their use are nearly as vast as the number of organizations that have implemented such programs. Rewards are issued in response to spending and are usually made available for use at some point after the reward is earned through a purchase transaction. In other words, rewards are most often earned at the time of the purchase transaction but are issued in accordance with a predefined interval. Rewards are often issued at the end of each billing cycle (e.g., monthly). As such, for example, rewards earned in one month may not be available for redemption until the following month.

However, U.S. Pat. App. Pub. No. 2008/0133351, published on Jun. 5, 2008 and entitled “Method and Apparatus for Reward Messaging, Discounting and Redemption at the Point of Interaction”, discloses a system configured to deliver real time discounts at the point of sale.

### BRIEF DESCRIPTION OF THE DRAWINGS

The embodiments are illustrated by way of example and not limitation in the figures of the accompanying drawings in which like references indicate similar elements.

FIG. 1 is a system diagram showing the relationships among various entities and computing systems under the control of the respective entities for facilitating a transaction and providing exemplary real-time reward issuance and redemption according to one embodiment.

FIG. 2A is a flow diagram showing processing of a purchase transaction with instant reward issuance and redemption according to one embodiment.

FIG. 2B is a flow diagram, continuing from FIG. 2A, processing of a purchase transaction with instant reward issuance and redemption according to one embodiment.

FIG. 3 is a block diagram providing a more detailed view of the various computing systems and components for facilitating the disclosed features according to one embodiment.

FIG. 4 illustrates a transaction terminal for processing a purchase transaction with instant reward issuance and redemption according to one embodiment.

FIG. 5 illustrates a payment instrument for facilitating payment for a purchase transaction with instant reward issuance and redemption according to one embodiment.

FIG. 6 illustrates an overview of a data processing system for processing a purchase transaction with instant reward issuance and redemption according to one embodiment.

### DETAILED DESCRIPTION

### Introduction

Benefits of offers (e.g., promotions) can be provided to cardholders in the form of purchase discounts or rebates on predefined purchases. The cardholders may include consumers who have been issued a payment instrument in the form of, for example, a credit card, debit card, gift card, prepaid card, calling card, etc. The payment instrument may be used by the cardholder to facilitate payments for purchases from merchants and service providers. A payment instrument corresponds to and identifies a cardholder account such as, for example, a credit account, debit account, prepaid account, bank account, stored value account and the like. In some instances, information identifying the cardholder account can be used directly in making payments without the use of a payment instrument in the form of a “card”.

Offers may be configured to encourage cardholder spending activity in specific markets and/or at specific times. Cardholders may be selected to receive specific offers based on, for example, historical transaction data, payment data, demographic data, spending trends, and the like.

For example, transaction data, such as records of transactions made via credit accounts, debit accounts, prepaid accounts, bank accounts, stored value accounts and the like, is processed to provide information for various services, such as reporting, benchmarking, advertising, content or offer selection, customization, personalization, prioritization, etc. Cardholders are typically required to enroll in a service program and provide consent to allow a system to use related transaction data and/or other data for the related services. The system is configured to provide the services while protecting the privacy of the cardholders in accordance with the enrollment agreement and user consent.

Offers can be optionally associated with specific payment instruments to facilitate the automated redemption of the benefits of the offers and may include terms defining how the benefit of the offer (e.g., reward, discount) is to be earned and redeemed by the cardholder. An offer may represent an opportunity for the cardholder to receive a reward having an associated monetary value, which may be deducted from a full purchase amount for a current and/or future cardholder purchase.

For example, a reward can be earned and redeemed in accordance with a certain offer in response to a purchase being executed in accordance with the terms of the offer (e.g., a specific product purchased from a specific merchant before a specified date). More specifically, when the cardholder makes a purchase within the terms of an offer and uses a payment instrument to facilitate payment to the merchant, transaction data for the payment, including the full purchase amount, merchant information and payment instrument information, is transmitted from the transaction terminal of the merchant to an issuer of the account of the cardholder in the form of an authorization request over a payment network. Such transaction data can be used to facilitate the provision of the reward during the authorization phase of the transaction and thus reduce the time period between the transaction and the provision of the reward.

In one embodiment, an issuer processor operated by the cardholder account issuer is configured to process offers during the authorization phase of the transaction using transaction data received via the authorization request. The issuer processor is configured to receive the authorization request and match the payment instrument information identified in the authorization request to stored offers. For example, an offer record having an identifier associated with the payment instrument identified in the authorization request is retrieved and determined to be applicable to the transaction; and in response, a new payment amount is calculated by subtracting a reward amount, as indicated in the offer record, from the full purchase amount identified in the authorization request. The issuer processor then performs a partial authorization of the payment transaction, as a response to the authorization request. In the partial authorization, the authorization is limited to the new purchase amount that is lower than the full purchase amount that was identified in the authorization request. The partial authorization is transmitted by the issuer processor in an authorization response to the transaction terminal of the merchant.

Since the issuer processor is configured to identify the eligibility of the transaction to the benefit of the offer, the authorization request transmitted to the issuer processor does not have to include information about the offer. Thus, the amount of information to be transmitted to the issuer processor during the authorization phase is reduced.

Further, a standard authorization response for partial authorization is modified to accommodate the use of the partial authorization for the provision of offer benefits to the cardholder.

Partial authorization is typically used to authorize a transaction amount lower than the requested transaction amount, when the funds available in the cardholder account are less than the full amount of the transaction. The partial authorization allows the cardholder to use the limited funds in the cardholder account with other source(s) of payments, such as cash or another payment card, to tender the full amount for the transaction. In view of the partial authorization, the transaction terminal of the merchant system is typically configured to prompt the user to present a separate payment source to cover the difference between the amount authorized by the partial authorization and the full amount of the transaction as initially identified in the authorization request.

When the partial authorization message set is used for the reward of offer benefits, the message system is modified to include an indication that the difference between the authorized amount identified in the partial authorization and the full amount of the transaction identified in the authorization request is a benefit provided to the cardholder, thus causing the transaction terminal of the merchant to avoid prompting the cardholder to present an additional payment source to cover the difference between the authorized amount identified in the partial authorization and the full amount of the transaction identified in the authorization request.

With such a modification, the partial authorization message set can support both the split payment scenario, in which the cardholder account does not have sufficient funds to cover the full transaction and thus funds from one or more additional payment sources are required to complete the transaction at the transaction terminal, and the offer benefit provision scenario, in which the difference between the authorized amount identified in the partial authorization and the full amount of the transaction identified in the authorization request represents a benefit provided to the cardholder and does not require an additional payment from the cardholder to complete the transaction at the transaction terminal. Thus, the same message set for partial authorization can be used in two distinct scenarios: one requiring an additional payment from the cardholder, and one requiring no additional payment from the cardholder.

An example of such a modification is the addition of a field to indicate whether the partial authorization is due to insufficient funds in the cardholder account, or a benefit provided to the cardholder account.

To further convey the information about the offer redemption, the authorization response may be configured to include a field containing information suitable for presentation to the cardholder on the sales receipt produced by the transaction terminal of the merchant on a piece of paper or electronically. Such information may indicate that a reward was issued, redeemed and applied to the present purchase via partial authorization. Such a field may be used to host a promotion description that includes information about a promotion qualification while the cardholder is at the merchant location. The promotion description field may further include a personalized message relating to the issuance and redemption of a reward. The authorization response may be further configured to include a field to identify the offer (e.g., an identifier of the offer known to the merchant system, such as a promotion code that identifies the specific promotion for which the purchase transaction qualifies) to allow the merchant system to track the redemption of the offer. The transaction terminal may optionally use the offer identifier to retrieve detail information of the offer, allowing the operator of the transaction terminal to determine whether to accept the transaction or reject the transaction. If the operator of the transaction terminal rejects the benefit provided to the transaction via the partial authorization, the cardholder may optionally complete the transaction via providing an additional payment to cover the difference between the authorized transaction amount and the full transaction amount.

For example, when the redemption of the offer is based on certain information available in the merchant system but not at the issuer system, such as the item-level purchase information that requires the purchase to include a specific product or service, the issuer system can use the partial authorization to provisionally provide the benefit of the offer, identifying the offer to the transaction terminal to allow the merchant to check additional requirements for final approval of the benefit of the offer. Such an arrangement reduces the amount of information to be transmitted across the payment network, while allowing redemption criteria to be formulated based on information separately available on the merchant system and the issuer system.

In some instances when the benefit of the offer is not sponsored by the merchant, the authorization message is further configured to identify the sponsor of the offer. Thus, during the settlement of the transaction, the transaction handler communicates not only with the issuer processor and the acquirer processor to settle the reduced, authorized amount for the transaction using the funds from the cardholder account, but with the sponsor to settle the cost for the benefit of offer provided to the cardholder.

Practitioners will appreciate that settlement between the disclosed entities may be facilitated in a variety of ways including, for example, using a new field in the modified authorization response (e.g., the promotion code) to match an electronic transfer from the issuer with the appropriate transaction record at the acquirer in order to properly credit the merchant's account for the original full purchase amount where a partial authorization was performed based on an offer redemption.

### System

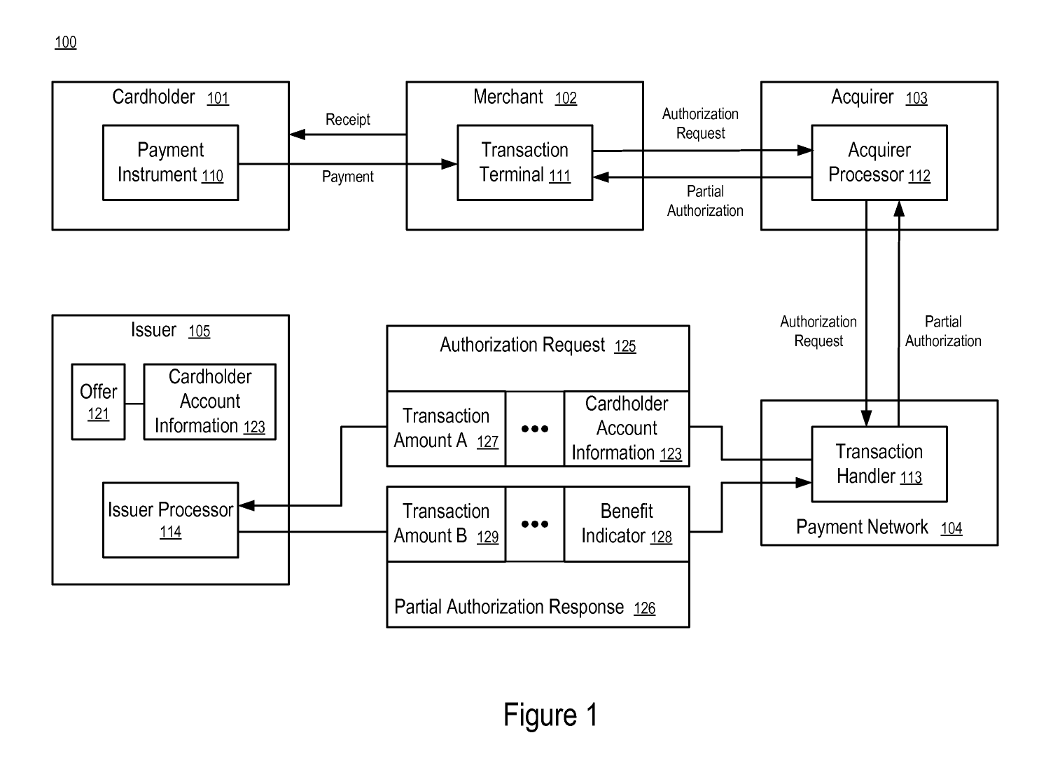

FIG. 1 is a system diagram showing the relationships among various entities and computing systems under the control of the respective entities for facilitating a transaction and providing exemplary real-time reward issuance and redemption according to one embodiment. The system includes a transaction handler (113) of a payment network (104) that communicates with an acquirer processor (112) to receive transaction data in the form of an authorization request from an acquirer processor (112) that resides with an acquirer (103). The transaction data includes information from a payment instrument (110), which is obtained and processed by a transaction terminal (111) during a payment transaction for a purchase between a cardholder (101) and a merchant (102). The transaction data further includes a full transaction amount for the purchase, to be authorized in a cardholder account that is associated with the payment instrument (110).

The transaction handler (113) sends the authorization request to an issuer processor (114), which processes the authorization request to determine whether to authorize the payment transaction between the cardholder (101) and the merchant (102) for the purchase made by the cardholder (101). The issuer processor (114) also determines whether the transaction data included in the authorization request corresponds with an offer (121) provided to the cardholder (101). When such an offer (121) exists and can be applied to the authorization request (e.g., satisfying the redemption requirements based on the information provided in the authorization request that was generated by the transaction terminal (111) of the merchant (102)), the issuer processor (114) calculates a new transaction amount by subtracting the amount of the benefit of the offer (121) from the full transaction amount identified in the authorization request submitted by the transaction terminal (111). The issuer processor (114) performs a partial authorization based on the new transaction amount.

The transaction handler (113) receives an authorization response from the issuer processor (114). The authorization response includes the partial authorization for a new transaction amount that is less than the full transaction amount that was identified in the authorization request. In response to receiving the authorization response from the issuer processor (114), the transaction handler (113) sends the authorization response to the acquirer processor (112), which processes the authorization response as a partial authorization before sending the authorization response to the transaction terminal (111) to finalize the purchase transaction between the cardholder (101) and merchant (102).

As used herein, the cardholder (101) may include any person, organization, or entity that is associated with the cardholder account identified by the cardholder account information (123). The cardholder (101) is the owner and/or authorized user of the cardholder account. The cardholder (101) may use a payment instrument (110) to identify the cardholder account issued to the cardholder (101) by the issuer (105). The payment instrument (110) is associated with and identifies the cardholder account (e.g., via providing the cardholder account information (123)), allowing the cardholder (101) to make payment transactions using the cardholder account.

An example of the payment instrument (110) discussed herein is a card-like device such as a credit card. However, practitioners will appreciate that the payment instrument (110) may take many forms including, for example, a magnetic strip card; smartcard; radio transceiver; cellular telephone; personal computing device; tablet computer; etc. Moreover, while the carrier of the payment instrument (110) is referenced herein as a “cardholder (101)”, practitioners will appreciate that the cardholder (101) is not limited to the use of a particular form and type of payment instrument (110).

The cardholder account may have a revolving line of credit, when the payment instrument (110) is a credit card. Alternatively, the cardholder account may be a deposit account, when the payment instrument (110) is a debit card. In another example, the cardholder account is designated to maintain a monetary value, wherein the monetary value is prepaid by or credited for the cardholder (101) or another authorized entity. Such prepaid accounts may have an associated payment instrument (101) that may include, for example, a prepaid phone card, prepaid credit card, prepaid debit card, wireless services card, transportation card, gift card, and the like.

In one embodiment, the cardholder (101) may utilize any of the payment instruments (110) described herein to facilitate a financial transaction with the merchant (102). As used herein, the merchant (102) may include any person, organization, or entity that provides goods and/or services in exchange for a monetary value provided via the cardholder account. The merchant (102) may include, for example, a fixed location merchant (“brick and mortar”), an online merchant, a catalog merchant, a mobile service provider, etc.

The transaction terminal (111) of the merchant (102) is configured to read cardholder account information (123) from the payment instrument (110), generate an authorization request identifying the cardholder account information (123), and transmit the authorization request to the acquirer processor (112) over a network in order to obtain a payment authorization. As previously described, the cardholder account information (123) may be obtained from the payment instrument (110) (e.g., credit card) in an automated way (e.g., using a magnetic strip reader, a bar code scanner, a smart card reader, etc.). Alternatively, the cardholder account information (123) may be entered via a keypad of the transaction terminal (111) by the cardholder (101) or merchant (102) without using the payment instrument (110), or may be read from the payment instrument (110) using a reader device that is attached to or in communication with the transaction terminal (111).

Examples of the reader device include a magnetic strip reader, smartcard reader, barcode reader, radio frequency transceiver or any other device configured to read printed, stored and/or encoded information from a payment instrument (110). The cardholder account information (123) obtained in the transaction terminal (111) of the merchant (102), through any of the means disclosed herein or known in the field, may be combined with purchase information including, for example, a full purchase amount and a merchant identifier to create an authorization request for the payment transaction from the cardholder account, under the control of the issuer processor (114), to a merchant account under the control of the acquirer processor (112).

As user herein, the acquirer processor (112) is configured to receive the authorization request, process the request, and route it over a network to an appropriate transaction handler (113), which is described in greater detail herein. The acquirer processor (112) may reside at an acquirer (103), which may comprise a bank that has entered into a contractual agreement with merchant (102) to obtain authorizations for payments to the merchant (102) and to receive the payments in the merchant account on behalf of the merchant (101) in the authorized payment transactions.

The transaction handler (113) is configured to receive authorization requests from one or more acquirer processors (e.g., 112) and route the authorization request to the appropriate issuer processor (e.g., 114), as will be described in greater detail below. The transaction handler (113) is configured to facilitate the clearing and settlement of authorized transactions, which may involve the transferring of money from the issuer (105) to the acquirer (103) for an authorized transaction.

The issuer processor (114) is configured to receive an authorization request from the transaction handler (113), process the authorization request, and issue an authorization response indicating whether the transaction is approved or declined. For example, the issuer processor (114) may parse the authorization request to obtain the cardholder account information (123), which is used to validate the transaction against the cardholder account, such as verifying that the parameters of the transaction (e.g., transaction amount) are within defined limits for the associated cardholder account. Further, the issuer processor (114) is configured to use the cardholder account information (123) to identify an offer (121) that is stored, in the issuer system, in association with the cardholder account information (123) and determine whether the current transaction to be authorized is eligible for the benefit of the offer (121); and if so, the benefit of the offer (121) is provided via a partial authorization of the transaction, in which the authorized transaction amount is lower than the transaction amount specified in the authorization request generated by the transaction terminal (111).

The issuer processor (114) typically resides at an issuer (105). In many cases, the issuer (105) is a banking institution that issues to the cardholder (101) the cardholder account and/or an associated payment instrument (110) that is configured to provide the cardholder account information to identify the cardholder account. The issuer (105) is configured to make payments on behalf of the cardholder (101) for transactions authorized in the cardholder account. The payment instrument (110) may be co-branded by both the issuer (105) and the payment network (104).

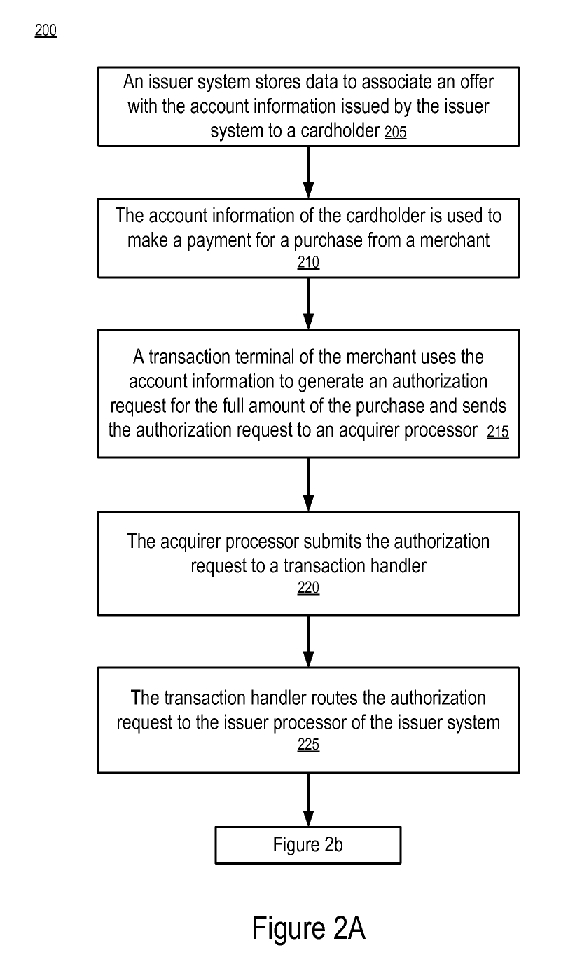

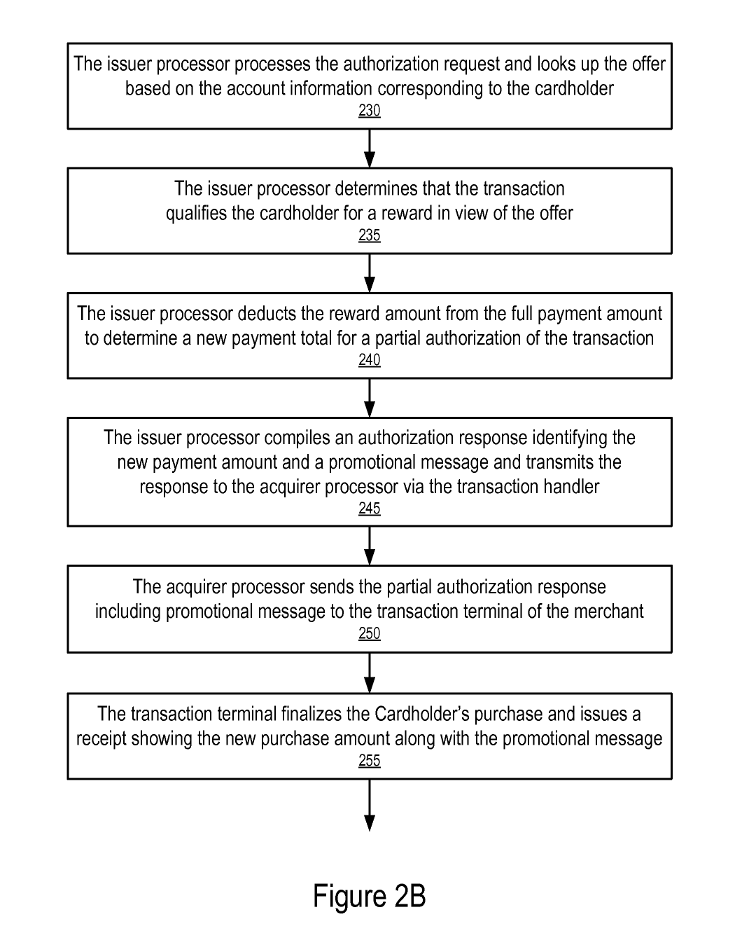

FIG. 2A is a flow diagram showing processing of a purchase transaction with reward issuance and redemption according to one embodiment. Reference to various elements and components from FIG. 1 will be made in the following discussion of FIG. 2A.

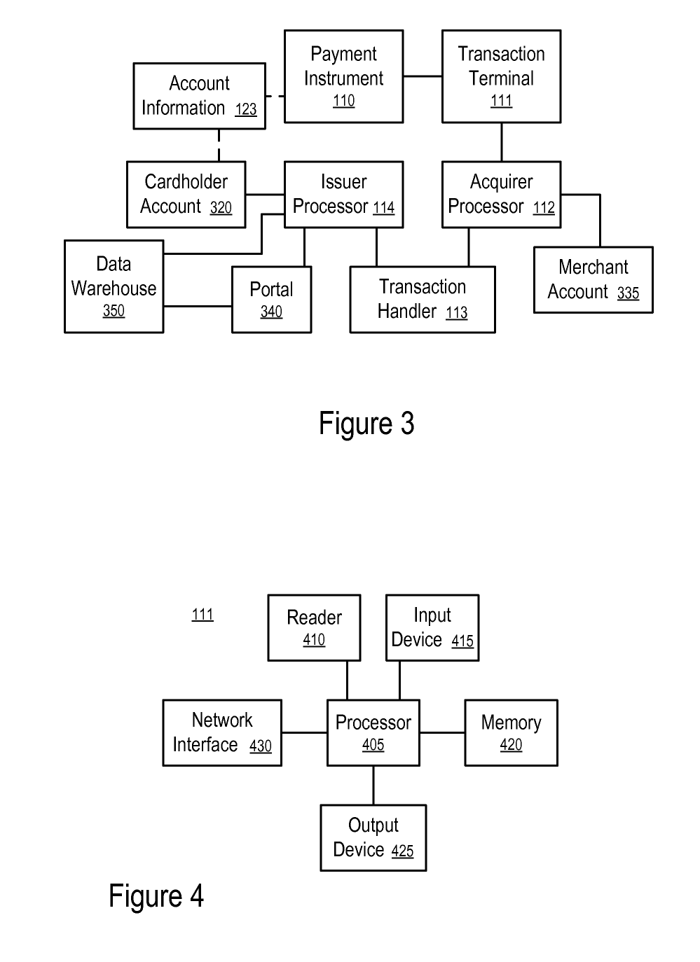

As previously noted, the cardholder (101) may be selected (e.g., by the issuer (105), or the merchant (102)) to receive an offer (121) based on an analysis of historical purchase data, payment data, demographics, etc. In block 205, the system of the issuer (105) is configured to store data associating the offer (121) with the account information (123) of the cardholder (101) (e.g., in data warehouse (350) illustrated in FIG. 3). The offer (121) may be sent to the cardholder (101) by various approaches, including email, Short Message Service (SMS), postal mailing, and a web page. The offer (121) may include, for example, a benefit to deduct $5.00 from the cardholder's (101) next purchase amount from the merchant (102). The system (100) is configured to allow the cardholder (101) to receive a reward of the benefit automatically when making the required next purchase from the merchant (102), with or without prior notification from the issuer (105). Thus, issuance of a reward notification is not a requirement for providing the cardholder (101) with the reward at the time of the next purchase.

As previously noted and as practitioners will appreciate, the offer (121) can take various forms and be provided to the cardholder (101) by various means. For example, an offer (121) may be printed on a sales receipt when the cardholder (101) makes a qualifying purchase from the merchant (102). In another example, the merchant (102) may send the offer (121) to the cardholder (101) via email or SMS.

When the cardholder (101) having the offer (121) makes a payment for the purchase, required for the redemption of the benefit of the offer (121), from the merchant (102) in block 210, the transaction terminal (111) of the merchant (102) processes the transaction for the full purchase amount, as in block 215. For example, the cardholder (101) makes a $50.00 purchase from the merchant (102); and the transaction terminal (111) of the merchant (102) processes the transaction for the full purchase amount of $50.00. The transaction terminal (111) may calculate sales taxes and any other fees that may be applicable to the purchase based on the full purchase amount to identify the amount of the payment transaction. Alternatively, the transaction terminal (111) may identify the transaction amount without calculating the sales tax and/or any other fee until after the authorization response is received, which may include the application of the discount offer (121).

The system (100) does not impose specific requirement for the merchant (102) (e.g., the operator of the transaction terminal (111)) to have specific knowledge of pending offers (e.g., 121) or maintain information regarding the cardholder's eligibility to benefit from the offer (121) at the time of the transaction at the transaction terminal (111). As such, the application of the offer (121) to the purchase transaction can be performed by the system (100) without special handling by the merchant (102) (e.g., the operator of the transaction terminal (111)) beyond what is required for a normal payment transaction between the cardholder (101) and merchant (102). However, practitioners will appreciate that some general knowledge by the merchant (102) of the reward might be helpful, in that the final transaction amount will not match the full purchase amount when a reward is issued and deducted from the purchase amount of the cardholder (101).

In block 215, the processing by the transaction terminal (111) includes calculating the full purchase amount and constructing an authorization request that identifies the cardholder account information (123) and transaction information, which includes the full transaction amount for the requested payment from the cardholder account of the cardholder (101) to the merchant account of the merchant (102). The transaction terminal (111) sends the authorization request over a communication connection to the acquirer processor (112).

While a specific example is described above for creating an authorization request, practitioners will appreciate that the compilation and processing of an authorization request may be facilitated in a variety of manners and in accordance with the transaction type. For example, a purchase executed online through a merchant website may not be processed by a transaction terminal (111) physically located within the establishment of the merchant. An online purchase transaction may be routed from a third-party “shopping cart” provider, which functions as a transaction terminal, over a network to generate the is received and processed by an acquirer processor (112).

Regardless of how the authorization request is received by the acquirer (103), in block 220, the acquirer processor (112) submits the authorization request to the transaction handler (113) where it is received and processed by the transaction handler (113). The acquirer processor (112) may select the appropriate transaction handler (113) based on information presented in the authorization request when the acquirer processor (112) is connected to a plurality of different payment networks. In some implementations, some or all of the various features of the transaction handler (113) may be provided by the acquirer (103), or any other entity, system, and/or component disclosed herein.

The transaction handler (113) receives the authorization request from the acquirer processor (112), identifies an issuer (105) based on information identified in the authorization request, formats the authorization request in accordance with requirements of the identified issuer (105), and/or transmits the formatted authorization request over a network to the issuer processor (114) of the identified issuer (105) (block 225) where it is received and processed by an issuer processor (114).

Practitioners will appreciate that the transaction handler (113) may perform additional or fewer features than those described herein without departing from the scope of the disclosure. For example, the transaction handler (113) of the payment network (104) and the issuer processor (114) of the issuer (105) may be combined in some implementations, wherein processing of the authorization request in accordance with the issuer (105) requirements may not be relevant or required.

Referring to FIG. 2B, when the issuer processor (114) receives the authorization request, the request is processed in order to extract or obtain various types of information. As previously described, this information includes data that is specific to the cardholder (101), the merchant (102), and the transaction. In block 230, the account information (123), configured to uniquely identify the cardholder account from a plurality of accounts issued by the issuer 9105) and that was obtained from the cardholder's payment instrument (110) in some scenarios, is used by the issuer processor (114) to lookup the offer (121) that is in associated with the cardholder account according to the data stored in the issuer system. After the offer (121) is identified from this account information (123), the issuer processor (114) determines in block 235 that the cardholder (101) is eligible to receive a reward afforded by the offer (121) associated with the cardholder account information (123) and that the reward may be applied to the current payment transaction between the merchant (102) and the cardholder (101).

In block 240, a partial authorization capability, configured to allow a customer to pay for a transaction using multiple sources of funds, including a cardholder account having available funds less than the full transaction amount, is used to provide the card holder (101) the reward benefit of the associated offer (121).

Practitioners will appreciate that some merchants have opted to allow customers to issue payment for a single purchase transaction using more than one form of payment. For example, a customer making an $80 purchase from a merchant may instruct the merchant to process the payment using his credit card. However, the customer may have only $60 of available credit in the credit account. Under the traditional model, the transaction would be declined by the cardholder account issuer and the customer (101) could choose to either back out of the transaction or select a different payment method.

To allow cardholders to utilize their maximum spending capacity and to reduce the loss of potential revenue to merchants due to declined purchase transactions, a partial authorization capability may be used. For example, when the issuer processor (114) determines that insufficient funds are available to satisfy the full transaction amount indicated in the authorization request, the issuer processor (114) may send an authorization response to the merchant (102) with an indication that a partial amount of the full transaction was authorized. Using the above example, the transaction is partially authorized for $60, such that the merchant (102) is to collect the additional $20 from the cardholder (101) through another means.

However, in FIG. 2B, the partial authorization capability typically used for situations involve insufficient funds in the cardholder account is extended to provide the benefit offer (121) in terms of a discounted transaction amount.

Thus, when a cardholder (101) makes a purchase from a merchant (102) within the terms of the offer (121), the issuer processor (114) determines that the cardholder (101) is eligible to receive a benefit reward based on the offer (121), the reward is provided as a discount amount applied to the current transaction authorized via the partial authorization. The issuer processor (114) is configured to provide in the authorization response (129) an benefit indicator (128) to indicate that the partial authorization is provided due to a reward of the offer (121), not due to insufficient funds in the cardholder account, which indication is configured to prevent the transaction terminal (111) from prompting the cardholder (101) to use a further payment source to cover the difference between the amount (129) authorized by the partial authorization response (126) and the full transaction amount (127) initially requested by the transaction terminal (111) in the authorization request (125).

The partial authorization response (126) generated by the issuer processor (114) may optionally include a message identifying the offer (121) applied to the transaction, which can be presented on the transaction terminal (111) to prompt the operator of the transaction terminal (111) to accept the reduced transaction amount and/or be included in the transaction receipt produced by the transaction terminal (111) to notify the cardholder (101) of the instant reward of the benefit applied to the transaction initiated using the payment instrument (110) in the form of a discounted transaction amount.

Since the partial authorization response (126) authorizes a discounted transaction amount (129) that is less than the full transaction amount (127) requested in the authorization request (125), the issuer processor (114) performs a partial authorization when the cardholder (101) is eligible for a reward of a monetary value. For example, when the transaction is eligible for a 10% discount, an authorization in the cardholder account having only $45.00 of available credit may be provided even though the authorization request requires a full purchase amount of $50.00. Because the cardholder (101) is eligible to receive a reward of $5.00 based on the purchase transaction, the issuer processor (114) can perform a partial authorization for the amount of $45.00 rather than a full authorization for $50.00.

The partial authorization response (126) from the issuer processor (114) is configured in one implementation to include an indication that a partial authorization was performed, as well as information regarding the issuance and redemption of the reward that the cardholder (101) was eligible to receive in view of the offer (121) and the reward amount or new purchase amount. In other implementations, the specification of the reduced transaction amount (129), different from the full transaction amount (127), is used at least in part to indicate the partial authorization.

After the issuer processor (114) has verified account information relative to the authorization request, the issuer processor (114) constructs the authorization response (126) in block 245, which includes information specific to the authorization of the purchase transaction and optionally, a promotional message. The authorization response may also include an indication that a partial authorization was performed, as well as information regarding the issuance and redemption of a reward that the cardholder (101) was eligible to receive and a reward amount. The transaction handler (113) receives the authorization response and processes it in order to determine how and where to send the authorization response. In block 245, the transaction handler (113) sends the authorization response, including information relating to the partial authorization, to the acquirer processor (112).

The promotional message provided in the authorization response (126) may include details about the reward and/or information relating to future promotion eligibility. For example, a new or existing authorization response field could be used to transport additional information about the reward, such that the merchant (102) and/or the cardholder (101) is notified about the reward issuance and redemption. In a specific example, the issuer processor (114) may insert a promotional and/or notification message stating, “Thank you Mr. Smith for your loyal business with Tom's Sporting Goods and because you are a valued customer, we have deducted $5.00 from today's purchase.”

The issuer processor (114) may transmit information relating to a reward by repurposing an existing field in a standard authorization response and use the existing field to send reward information back to the transaction terminal (111) of the merchant (102). Such an approach requires minimal or no modification to the existing payment infrastructure.

A notification module or component of the issuer processor (114) may optionally use the contact information of the cardholder (101) retrieved while processing the authorization request (125) to notify the cardholder (101) of the reward provided via the partial authorization response (126). The contact information may include, for example, a cell phone number or an email address. The notification module or component sends a message to the cardholder's phone by way of SMS or send an email to the cardholder (101) that includes details of the current transaction, reward eligibility, reward details, upcoming promotion announcements, and the like.

The acquirer processor (112) is configured to receive the authorization response from the transaction handler (104). In block 250, the acquirer processor sends the partial authorization response (126) including the promotional message to the transaction terminal (111) of the merchant (102).

In block 255, the transaction terminal (111) finalizes the cardholder's purchase and issues a receipt showing the new, discounted transaction amount (with reward deduction), the optional promotional message, and optionally the full purchase amount. The receipt may be printed and/or provided electronically to the cardholder (101).

During clearing and settlement of the transaction authorized by the partial authorization response (126), the transaction handler (113) is configured to communicate with the issuer processor (114) and the acquirer processor (112) to transfer funds from the cardholder account to the merchant account in accordance with the reduced transaction amount (129) authorized by the partial authorization response (126).

Alternatively, the acquirer (103) may optionally credit the merchant (102) for the full amount (127) of the transaction; therefore, a deficit will exist at the acquirer (103) due to the difference in the amount received from the account of the cardholder (101) at the issuer (105) and the amount that the acquirer (103) credited to the account of the merchant (102). For example, when the benefit of the offer (121) is provided to the cardholder (101) by an entity other than the merchant (102), the entity sponsoring the offer (121) would be responsible for providing the difference between the full purchase amount (127) as indicated in the authorization request (125) generated by the transaction terminal (111) and the discounted new purchase amount (129) as authorized by the issuer processor (114) via the partial authorization response (126). The transaction handler (113) and/or the issuer processor (114) may optionally be configured to settle further a transaction between the acquirer (103) and the entity sponsoring the offer (121) for the cost of the benefit provided via the partial authorization response (126). Settlement may be facilitated through an automated clearinghouse (ACH). For example, in the above example, the transaction handler (113) and/or the issuer processor (114) may reconcile the difference between the full purchase amount (e.g., $50.00) and the new purchase amount (e.g., $45.00) via an additional transaction between the entity sponsoring the offer (121) and the acquirer (103), during the clearing and settlement of the transaction authorized by the partial authorization response (126).

Optionally, an interface is provided via a portal (340) (illustrated in FIG. 4) to allow a promotion to be created and configured by an offer provider and/or be associated with the cardholder account information (123). The promotion interface allows an offer provider to define eligibility parameters, start and end dates, etc. The offer provider may optionally have an account with the issuer (105) that maintains funds that are used to compensate the merchant (102) or acquirer (103) for issued and redeemed rewards. Through the promotion interface, the offer provider may identify specific cardholders (101) as being qualified for an offer (121) based on spending, length of time as a cardholder, demographics, payment history, and the like. For example, the cardholder (101) may use the interface to associate a received offer with the cardholder account information (123) for subsequent automated redemption. For example, the merchant (102) may use the interface to associate an offer (121) with the cardholder account information (123) in response to the cardholder account information (123) being used in the payment of an earlier purchase, so that the benefit of the offer (121) can be provided to the cardholder (101) in an automated way via the partial authorization response (126) for a later purchase in which the same cardholder account information (123) is used to make the payment.

A reward for the merchant (102) may be optionally provided and configured to be calculated from a percentage of the cardholder's (101) reward, for example. Implementation of such a reward structure may encourage merchants to in-turn encourage their customers to use a specific payment instrument for purchases, knowing that if the cardholder (101) is eligible for a reward, the merchant (102) may also benefit from the reward.

In general, the reward offers (e.g., 121) may be provided by any entity, not restricted to the issuer (105) and/or the merchant (102). For example, the issuer (105) may be responsible for implementing a reward program and/or compensating the acquirer (103) for the reward that is issued to the cardholder (101) in one example; in another example, the issuer (105) may allow the merchant (102) or a third-party to participate in offering rewards based on any number of criteria. For example, a manufacturer (e.g., Fisher Price Toys) may provide the offer (121) to be implemented via the disclosed reward issuance and redemption features, implemented via the partial authorization response (126) provided via the issuer processor (114), to reward their customers at the point of sale for purchasing the products of the manufacturer. The authorization request (127) can be optionally configured to include information pertaining to the specific item being purchased; and the issuer processor (114) can be accordingly configured to determine eligibility for a reward based on item information such as a Universal Product Code (UPC), for example.

While FIG. 1 provides a general overview of the entities and their relationships with one another for carrying out the disclosed processes for selected embodiments, the following discussion provides additional detail regarding various hardware, software, and networking components that may be implemented for these and other embodiments in the payment network configuration. Practitioners will appreciate that various embodiments may require modification to existing software systems, particularly at the issuer (105), or at any other entity tasked with determining reward eligibility and calculating a new purchase amount based on reward issuance and redemption. The systems and components disclosed herein are presented for explanation and are not intended to limit the scope of the disclosure.

FIG. 3 is a block diagram providing a more-detailed view of the various computing systems and components used to facilitate the disclosed features in accordance with one embodiment. Practitioners will appreciate that in electronic commerce embodiments, certain features of the transaction terminal may be provided by a personal computer of the cardholder (101) along with applications running at a computer server that is in communication with the cardholder's computer by way of the Internet, for example.

In a typical storefront configuration, the merchant (102) is equipped with the transaction terminal (111). The transaction terminal (111) is configured to interact with a payment instrument (110) to obtain account information (123) about the cardholder's cardholder account (320).

FIG. 4 illustrates a transaction terminal device for processing a purchase transaction with reward issuance and redemption according to one embodiment. With reference to FIGS. 3 and 4, the transaction terminal (111) includes a memory (420) coupled to a processor (405) (e.g., a microprocessor or CPU), which controls the operations of a reader (410), an input device (415), an output device (425) and a network interface (430). The memory (420) may store instructions for the processor (405) and/or data, such as an identification that is associated with the merchant account (335).

The reader (410) may be a magnetic strip reader, a contactless reader, such as a radio frequency identification (RFID) reader, a near field communications (NFC) device configured to read data via magnetic field coupling (in accordance with ISO standard 14443/NFC), a Bluetooth transceiver, a Wi-Fi transceiver, an infrared transceiver, and/or a laser scanner, etc.

The input device (415) may include a keypad that can be used to enter the account information (123) directly into the transaction terminal (111) without the physical presence of the payment instrument (110). The input device (415) can be configured to provide further information to initiate a transaction, such as a personal identification number (PIN), password, zip code, etc. that may be used to access the payment instrument (110), or in combination with the account information (123) obtained from the payment instrument (110).

The output device (425) may include a display, a speaker, and/or a printer to present information, such as the result of an authorization request, a receipt for the transaction, an advertisement, etc.

The network interface (430) is configured to communicate with the acquirer processor (112) via a telephone connection, an Internet connection, and/or a dedicated data communication channel.

The instructions stored in the memory (420) are configured at least to cause the transaction terminal (111) to send an authorization request to the acquirer processor (112) to initiate a transaction. As described herein, the transaction may be routed and processed by the acquirer processor (112), the transaction handler (113), and the issuer processor (114) tasked with obtaining an authorization of the transaction facilitated through the payment instrument (110). The transaction terminal (111) may or may not send a separate request for the clearing and settling of the transaction. The instructions stored in the memory (420) are also configured to cause the transaction terminal (111) to perform other types of functions discussed in this description.

The transaction handler (113) is a payment processing system, or a payment instrument processor, such as a processor for credit cards, debit cards, etc.

Data relating to the features disclosed herein may be stored in a database system such as, for example data warehouse (350). Such data may include, for example, the association of the offer (121) with the account information (123), transaction information, merchant information, terms and conditions of the offer (121), etc.

The transaction terminal (111) used in FIG. 1 may have fewer or more components than those illustrated in FIG. 4. For example, when the transaction terminal (111) is configured for “card-not-present” transactions, the transaction terminal (111) does not require a reader (410). For example, the transaction terminal (111) may include components to dispense cash under certain conditions (e.g., changes).

Additional examples of computing systems and components that may be used to facilitate the disclosed features, such as targeting offers, processing transactions, providing rewards, etc., discussed above in accordance with various embodiments are provided in U.S. Pat. Pub. No. 2011/0035280, filed Aug. 3, 2010 and entitled “Systems and Methods for Targeted Advertisement Delivery,” the disclosure of which application is hereby incorporated herein by reference.

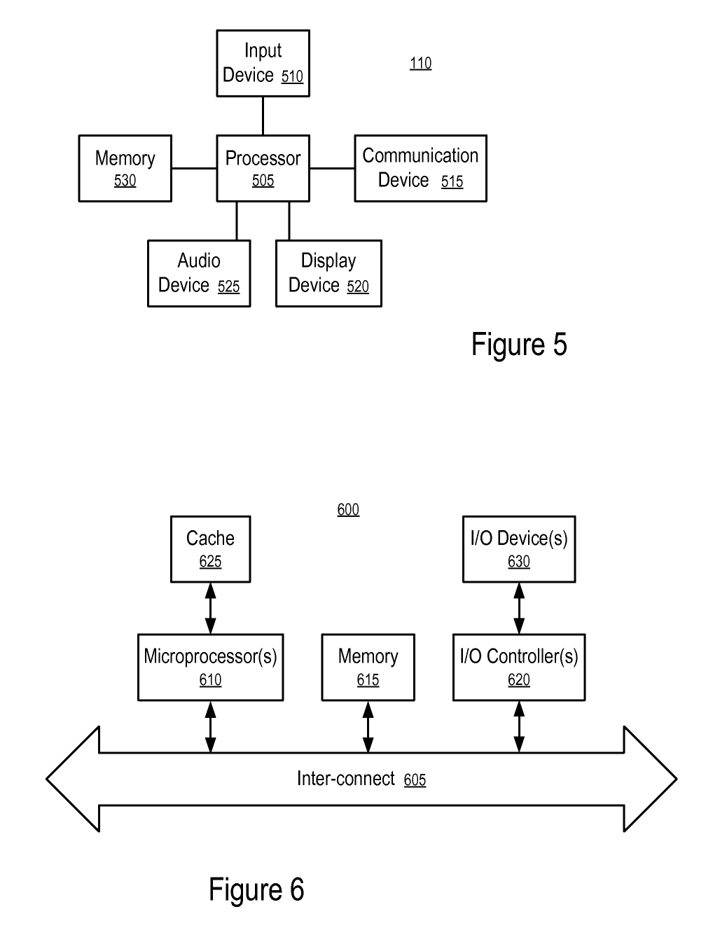

FIG. 5 illustrates a payment instrument according to one embodiment. In FIG. 5 with reference also to FIG. 3, the payment instrument (110) is configured to maintain cardholder account information (123) that identifies the cardholder account (320).

The payment instrument (110) may be implemented as a smartcard, which includes a memory (530) coupled to a processor (505) (e.g., a microprocessor or controller), which controls the operations of a communication device (515), an input device (510), an audio device (525) and a display device (520). The memory (530) may store instructions for the processor (505) and/or data, such as the account information (123) associated with the cardholder account (320).

The account information (123) includes an identifier identifying the issuer 9105) (and thus the issuer processor (114)) among a plurality of issuers, and an identifier identifying the cardholder account among a plurality of cardholder accounts issued and/or controlled by the issuer processor (114). The account information (123) may include an expiration date of the payment instrument (110), the name of the cardholder having the cardholder account (320), and/or an identifier identifying the payment instrument (110) among a plurality of payment instruments associated with the cardholder account (320).

The account information (123) may further include a reward program account number, accumulated rewards of the cardholder in the loyalty program, an address of the cardholder, a balance of the cardholder account (320), transit information (e.g., a subway or train pass), access information (e.g., access badges), and/or cardholder information (e.g., name, date of birth), etc.

The memory (530) may include a nonvolatile memory, such as magnetic strip, a memory chip, a flash memory, a Read Only Memory (ROM), etc. to store the account information (123).

The information stored in the memory (530) of the payment instrument (110) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

The communication device (515) may include a semiconductor chip to implement a transceiver for communication with a input device (510) and an antenna to provide and/or receive wireless signals.

The communication device (515) may be configured to communicate with the input device (510) to provide the account information (123). For example, the communication device (515) may include a transmitter to transmit the account information (123) via wireless transmissions, such as radio frequency signals, magnetic coupling, or infrared, Bluetooth or Wi-Fi signals, etc.

Alternatively, the payment instrument (110) may be in the form of a mobile phone, personal digital assistant (PDA), etc. The input device (510) can be used to provide input to the processor (505) to control the operation of the payment instrument (110); and the audio device (525) and the display device (520) may present status information and/or other information, such as advertisements or offers. The payment instrument (110) may further include components that are not shown, such as a cellular communications subsystem.

The communication device (515) may access the account information (123) stored on the memory (530) without going through the processor (505).

The payment instrument (110) used in FIG. 1 may have fewer components than those illustrated in FIG. 5. For example, a payment instrument (110) does not have the input device (510), the audio device (525) and the display device (520) in implementation; and in another implementation, a payment instrument (110) does not have components (505-525). For example, a payment instrument (110) in the form of a debit card, a credit card, a prepaid card may have a magnetic strip as the memory (530) to store and/or present account information (123); alternatively, a payment instrument (110) in the form of smartcards or electronic wallets can be used in FIG. 1.

An example of a payment instrument (110) is a magnetic strip attached to a plastic substrate in the form of a card. The magnetic strip is used as the memory (530) of the payment instrument (110) to provide the account information (123). Cardholder information, such as account number, expiration date, and cardholder name may be printed or embossed on the card. An optional semiconductor chip implementing the memory (530) and the communication device (515) may also be embedded in the plastic card to provide account information (123). In some implementations, the payment instrument (110) has the semiconductor chip but not the magnetic strip.

The payment instrument (110) can be optionally integrated with a security device, such as an access card, a radio frequency identification (RFID) tag, a security card, a transponder, etc.

The payment instrument (110) can be implemented in a handheld and compact device. Typically, the payment instrument (110) is configured to have a size suitable to be placed in a wallet or pocket of the cardholder.

Some examples of the payment instrument (110) used in FIG. 1 include a credit card, a debit card, a stored value device, a payment card, a gift card, a smartcard, a smart media card, a payroll card, a health care card, a wrist band, a keychain device, a supermarket discount card, a transponder, and a machine readable medium containing account information (123).

At least some of the apparatus illustrated in FIG. 1 such as the transaction terminal (111) of the merchant (102), the issuer processor (114) of the issuer (105), the acquirer processor (112) of the acquirer (103), and the transaction handler (113) of the payment network (105) can be implemented using a computer system, such as a data processing system illustrated in FIG. 5, with more or fewer components. Some of the apparatus may share hardware or be combined on a computer system. A network of computers can be used to implement some of the apparatuses, such as the transaction handle (113), the acquirer processor (112) and/or the issuer processor (114). In a typically implementation, each of the transaction terminal (111) of the merchant (102), the issuer processor (114) of the issuer (105), the acquirer processor (112) of the acquirer (103), the transaction handler (113) of the payment network (105), the data warehouse (350), and the portal (340) includes at least one microprocessor and memory storing instructions configured to instruct the at least one microprocessor to perform various operations discussed in the present disclosure.

FIG. 6 illustrates a data processing system according to one embodiment. While FIG. 6 illustrates various components of a computer system, it is not intended to represent any particular architecture or manner of interconnecting the components. One embodiment may use other systems that have fewer or more components than those shown in FIG. 6.

In FIG. 6, the data processing system (600) includes an inter-connect (605) (e.g., bus and system core logic), which interconnects a microprocessor(s) (610) and memory (420). The microprocessor (610) is coupled to cache memory (625) in this example.

The inter-connect (605) interconnects the microprocessor(s) (610) and the memory (615) together and also interconnects them to input/output (I/O) device(s) (630) via I/O controller(s) (620). I/O devices (630) may include a display device and/or peripheral devices, such as mice, keyboards, modems, network interfaces, printers, scanners, video cameras and other devices known in the art. In one embodiment, when the data processing system is a server system, some of the I/O devices (630), such as printers, scanners, mice, and/or keyboards, are optional.

The inter-connect (605) may include one or more buses connected to one another through various bridges, controllers and/or adapters; and the I/O controllers (620) may include a USB (Universal Serial Bus) adapter for controlling USB peripherals, and/or an IEEE-1394 bus adapter for controlling IEEE-1394 peripherals.

Examples of the memory (615) include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described herein can be implemented using special purpose circuitry, with or without software instructions, such as using Application-Specific Integrated Circuit (ASIC) or Field-Programmable Gate Array (FPGA). For example, the functions and operations can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be implemented, at least in part, in software for execution on hardware. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. that are transitory are not tangible machine readable medium and are not configured to store instructions.

In general, a machine readable medium includes any apparatus that provides, stores, and/or transmits information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. The present disclosure is illustrative of inventive features to enable a person skilled in the art to make and use the techniques. Various features, as described herein, should be used in compliance with all current and future rules, laws and regulations related to privacy, security, permission, consent, authorization, and others. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
receiving, in a computing apparatus under control of an issuer of an account, an authorization request from a transaction handler of a payment network for a payment transaction between a cardholder of the account and a merchant, the authorization request identifying a first transaction amount and including account information configured to identify the account among a plurality of accounts issued by the issuer;
processing, by the computing apparatus, the authorization request;
during the processing of the authorization request,
identifying, by the computing apparatus, an offer based on data stored in the computing apparatus, the data associating the offer with the account information,
determining, by the computing apparatus, that the payment transaction is eligible for a benefit reward in accordance with the offer,
determining, by the computing apparatus, a second transaction amount via applying the benefit reward to the first transaction amount, and
generating, by the computing apparatus, an authorization response to the authorization request, the authorization response authorizing in the payment transaction the second transaction amount but not the first transaction amount, the authorization response including an indication that a difference between the first transaction amount and the second transaction amount is not due to insufficient funds in the account; and
transmitting, by the computing apparatus, the authorization response to the transaction handler.

2. The method of claim 1, wherein, apart from the indication that the difference between the first transaction amount and the second transaction amount is not due to insufficient funds in the account, the authorization response is substantially in accordance with a message standard for partial authorization of transactions in accounts with insufficient funds for full transaction amounts.

3. The method of claim 2, wherein the authorization response further includes a message configured to be presented to the cardholder in a receipt produced by a transaction terminal of the merchant.

4. The method of claim 3, wherein the message identifies the reward benefit applied to the payment transaction.

5. The method of claim 4, wherein the message includes a description of the offer.

6. The method of claim 5, wherein the message is transmitted in the authorization response using a re-purposed field.

7. The method of claim 2, wherein the authorization response includes an identifier of the offer.

8. The method of claim 7, wherein the identifier of the offer is configured in a field of the authorization response to cause a transaction terminal on which the authorization request was initiated to present the offer to an operator of the transaction terminal for approval of reduction from the first transaction amount to the second transaction amount.

9. The method of claim 8, wherein the indication that the difference between the first transaction amount and the second transaction amount is not due to insufficient funds in the account includes the identifier of the offer.

10. The method of claim 9, wherein the indication that the difference between the first transaction amount and the second transaction amount is not due to insufficient funds in the account further includes a message of the offer.

11. The method of claim 10, wherein the message of the offer includes one or more terms and conditions of the offer.

12. The method of claim 2, further comprising:
storing, in the computing apparatus, the data associating the offer with the account information prior to the authorization request.

13. The method of claim 12, further comprising:
presenting a user interface to receive an input from the cardholder to associate the offer with the account information.

14. The method of claim 12, further comprising:
receiving an input from the merchant to associate the offer with the account information in connection with a separate transaction made using the account information.

15. The method of claim 13, further comprising:
providing a user interface to design and configure the offer.

16. A computer-storage media storing instructions configured to instruct a computing apparatus to at least:
receive, in the computing apparatus under control of an issuer of an account, an authorization request from a transaction handler of a payment network for a payment transaction between a cardholder of the account and a merchant, the authorization request identifying a first transaction amount and including account information configured to identify the account among a plurality of accounts issued by the issuer;
process, by the computing apparatus, the authorization request;
during processing of the authorization request,
identify, by the computing apparatus, an offer based on data stored in the computing apparatus, the data associating the offer with the account information,
determine, by the computing apparatus, that the payment transaction is eligible for a benefit reward in accordance with the offer,
determine, by the computing apparatus, a second transaction amount via applying the benefit reward to the first transaction amount, and
generate, by the computing apparatus, an authorization response to the authorization request, the authorization response authorizing in the payment transaction the second transaction amount but not the first transaction amount, the authorization response including an indication that a difference between the first transaction amount and the second transaction amount is not due to insufficient funds in the account; and
transmit, by the computing apparatus, the authorization response to the transaction handler.

17. A computing apparatus having at least a processor and a memory storing instructions configured to instruct the at least processor to perform operations, the computing apparatus comprising:
a data warehouse configured to store data associating an offer with account information identifying an account issued by an issuer; and
an issuer processor of the issuer coupled with the data warehouse to access the data associating the offer with the account information during processing of an authorization request received from a transaction handler of a payment network, the authorization request identifying the account information and a first transaction amount for a payment transaction in the account, the issuer processor configured to determine whether a benefit of the offer is applicable to the payment transaction and if so, compute a second transaction amount by applying the benefit of the offer to the first transaction amount and authorize the payment transaction for the second transaction amount reduced from the first transaction amount.

18. The computing apparatus of claim 17, wherein the issuer processor is configured to generate an authorization response to the authorization request and transmit the authorization response to the transaction handler, using a message standard substantially same for partial authorization of transactions in accounts with insufficient funds for full transaction amounts; wherein the authorization response further includes an indication that a difference between the first transaction amount and the second transaction amount is not due to insufficient funds in the account.

19. The computing apparatus of claim 18, wherein the indication identifies that the difference is due to a benefit provided to the transaction.

20. The computing apparatus of claim 18, wherein the authorization response identifies the offer; and the computing apparatus further includes a portal configured to design, configure and target the offer.
